(19) United States
(12) Patent Application Publication
(10) Pub. No.: US 2025/0278691 A1
(43) Pub. Date: Sep. 4, 2025

(54) NEXT GEN ETA MACHINE LEARNING (ML) SYSTEM

(71) Applicant: DoorDash, Inc., San Francisco, CA (US)

(72) Inventors: Chi Zhang, San Jose, CA (US); Ziqi Jiang, Santa Clara, CA (US); Qingyang Xu, Sunnyvale, CA (US); Lewis Warne, San Francisco, CA (US); Hubert Jenq, San Francisco, CA (US); Jianzhe Luo, Clyde Hill, WA (US); Pradeep Varma Mudunuru, Snohomish, WA (US)

(73) Assignee: DoorDash, Inc., San Francisco, CA (US)

(21) Appl. No.: 19/067,414

(22) Filed: Feb. 28, 2025

Related U.S. Application Data
(60) Provisional application No. 63/560,555, filed on Mar. 1, 2024.

(51) Int. Cl. G06Q 10/0833; G06N 3/045

(52) U.S. Cl. CPC G06Q 10/0833; G06N 3/045

(57) ABSTRACT

One embodiment of the invention includes a computer-implemented method comprising receiving, from an end user device, a request for a delivery; obtaining feature information including (1) retrieval information and (2) transporter information; generating a feature vector from the feature information; generating, using a machine learning model and the feature vector, a probability distribution representing probabilities for delivery times from the retrieval location; providing the probability distribution to a decision layer that includes a plurality of decision modules associated with different retrieval locations or types of retrieval locations, wherein the retrieval information includes an identifier corresponding to the retrieval location or a type of the retrieval location; selecting a decision module corresponding to the identifier; generating, by the decision module, a range of an estimated time of arrival of the transporter based on the probability distribution; and providing, to the end user device, the range of an estimated time of arrival.

### CROSS-REFERENCES TO RELATED APPLICATIONS

This is a Non-Provisional application, which claims priority to U.S. Provisional Application No. 63/560,555 filed on Mar. 1, 2024, which is herein incorporated by reference in its entirety.

### BACKGROUND

In an item fulfillment organization (e.g., a delivery service), “providers” (also referred to as “service providers” or “resource providers”) can prepare items for end users upon receiving item fulfillment requests from those end users. These items can be retrieved by “transporters” (e.g., delivery drivers) who can then transport the items to their respective end users, thereby servicing the fulfillment request. For example, in a food delivery service, an end user (e.g., a end user) can order a meal from a restaurant (service provider). A delivery driver (transporter) can then pick up that meal and drive it to the end user.

Item fulfillment organizations can provide to the end user a range of an estimated time of arrival so that the end user can anticipate when they will receive their item. The range of an estimated time of arrival can be a range of durations (e.g., 35-40 minutes) or a range of arrival times (e.g, 5:00 pm-5:15 pm). By providing an accurate and reliable range of an estimated time of arrival to the end user, item fulfillment organizations can enhance the end user experience.

The estimated time of arrival may be presented to an end user at various stages of the item fulfillment process and may be associated with a variety of delivery types, each scenario presenting unique challenges. For example, an end user may encounter the home page of an item fulfillment application and use the home page ETAs to help them decide between service providers. The features available for predicting these ETAs are limited because the prediction occurs before the end user has selected the items they wish to order, and the latency of all the features must be low to quickly predict ETAs for all the nearby stores. In another example, the end user may request an item for pick-up, and features related to available transporters may not be relevant.

Embodiments can address these and other problems individually and collectively.

### SUMMARY

Embodiments of the present disclosure are directed to systems and methods for determining a range of an estimated time of arrival in relation to item fulfillments. The range of an estimated time of arrival can be a time frame that an item is predicted to arrive within. As described herein, embodiments can provide a single model to accommodate a wide variety of scenarios and conditions without sacrificing consistency nor accuracy of predictions. Moreover, the model is scalable and can large volumes of data using the memory and computational power saved from training a single model instead of multiple task-specific models.

One embodiment of the disclosure includes a computer-implemented method comprising receiving, from an end user device, a request for a delivery; obtaining feature information including (1) retrieval information associated with a retrieval location from which an item is to be delivered by a transporter and (2) transporter information associated with a plurality of transporter devices of transporters that are currently active for the retrieval location; generating a feature vector from the feature information; generating, using a machine learning model and the feature vector, a probability distribution representing probabilities for delivery times from the retrieval location; providing the probability distribution to a decision layer that includes a plurality of decision modules associated with different retrieval locations or types of retrieval locations, wherein the retrieval information includes an identifier corresponding to the retrieval location or a type of the retrieval location; selecting a decision module corresponding to the identifier; generating, by the decision module, a range of an estimated time of arrival of the transporter based on the probability distribution; and providing, to the end user device, the range of an estimated time of arrival.

These and other embodiments of the disclosure are described in detail below. For example, other embodiments are directed to systems, devices, and computer readable media associated with methods described herein.

A better understanding of the nature and advantages of embodiments of the present disclosure may be gained with reference to the following detailed description and the accompanying drawings.

### TERMS

A “server computer” may refer to a computer or cluster of computers. A server computer may be a powerful computing system, such as a large mainframe. Server computers can also include minicomputer clusters or a group of servers functioning as a unit. In one example, a server computer can include a database server coupled to a web server. A server computer may comprise one or more computational apparatuses and may use any of a variety of computing structures, arrangements, and compilations for servicing requests from one or more client computers.

A “user” may refer to an entity that uses something for some purpose. An example of a user is a person who uses a “user device” (e.g., a smartphone, wearable device, laptop, tablet, desktop computer, etc.). Another example of a user is a person who uses some service, such as a person who uses a delivery service, a member of an online video streaming service, a person who uses a tax preparation service, a person who receives healthcare from a hospital or other organization, etc. A user may be associated with “user data,” data which describes the user or their use of something (e.g., their use of a user device or a service). In some circumstances, a user may be referred to as an “end user.”

A “user device” may be any suitable electronic device that can be used by a user. An exemplary user device can process and communicate information to other electronic devices. The user device may include a processor and a computer-readable medium coupled to the processor, the computer-readable medium comprising code, executable by the processor. The user device may also each include an external communication interface for communicating with other entities. Examples of user devices may include mobile devices such as mobile phones and laptop computers, wearable devices (e.g., glasses, rings, watches, etc.), hardware modules in larger devices such as vehicles (e.g., automobiles), etc.

A “transporter” can be an entity that transports something. For example, a transporter can be a person that transports an item using a transporter vehicle (e.g., a car). In other embodiments, a transporter can be a transporter vehicle that may or may not be operated by a human. Examples of transporter vehicles include cars, boats, scooters, bicycles, drones, airplanes, etc. Transporters can also include autonomous vehicles such as self-driving cars and unmanned drones.

A “fulfillment request” can be a request to provide a resource in response to the fulfillment request. For example, a fulfillment request can include an initial communication from an end user device to a central server computer for a first service provider computer to fulfill a purchase request for a resource, e.g., a purchase request for food from a restaurant. A fulfillment request can include one or more selected items from a selected service provider. A fulfillment request can also include user features of the end user providing the fulfillment request.

An “item” can include an individual article or unit. An item can be a thing that is provided by a service provider. Items can be goods, For example, bowls of soup, soda cans, toys, clothing, etc. An item can be delivered from a service provider location to an end user location by a transporter.

A “feature” can be an individual measurable property or characteristic of a phenomenon. One or more features can be described using a “feature vector,” e.g., a structured list of data (such as numerical data) representing those features. A feature can be input into a model to determine an output. As an example, in pattern recognition and machine learning, a feature vector can comprise an n-dimensional vector of numerical features that represent some object. In some machine learning contexts, a numerical representation of objects facilitate processing and statistical analysis. For image processing, for example, feature values might correspond to the pixels of an image. As another example, when feature vectors represent text, the features may comprise occurrence frequency of textual terms. Feature vectors can be equivalent to the vectors of explanatory variables used in statistical procedures such as linear regression.

“User features” can include attributes or aspects of a user. User features can include features that relate to a user. For example, in the context of a delivery service, user features can include order history, delivery location, dietary preferences, user ratings, user comments, user feedback, saved service providers, favorited service providers, a current location, food category preferences, delivery time thresholds (e.g., deliver within 1 hour, 45 minutes, etc.), budget preferences, and/or other data representative of, or input by, the user.

“Service provider features” can include attributes or aspects of a service provider. Service provider features can include features that relate to a service provider. Service provider features can include service provider details, cuisine, ratings, food category, service provider location(s), item production time, promoted items, item cost, and/or other data representative of the service provider and/or items provided by the service provider.

The term “artificial intelligence model” or “machine learning model” can include a model that may be used to predict outcomes to achieve a pre-defined goal. A machine learning model may be developed using a learning process, in which training data is classified based on known or inferred patterns.

“Machine learning” can include an artificial intelligence process in which software applications may be trained to make accurate predictions through learning. The predictions can be generated by applying input data to a predictive model formed from performing statistical analyses on aggregated data. A model can be trained using training data, such that the model may be used to make accurate predictions. The prediction can be, for example, a classification of an image (e.g., identifying images of cats on the Internet) or as another example, a recommendation (e.g., a movie that a user may like or a restaurant that a consumer might enjoy).

A “machine learning model” (ML model) can refer to a software module configured to be run on one or more processors to provide a classification or numerical value of a property of one or more samples. An ML model can include various parameters (e.g., for coefficients, weights, thresholds, functional properties of function, such as activation functions). As examples, an ML model can include at least 10, 100, 1,000, 5,000, 10,000, 50,000, 100,000, or one million parameters. An ML model can be generated using sample data (e.g., training samples) to make predictions on test data. Various number of training samples can be used, e.g., at least 10, 100, 1,000, 5,000, 10,000, 50,000, 100,000, or at least 200,000 training samples. One example is an unsupervised learning model such as hidden Markov model (HMM), clustering (e.g., hierarchical clustering, k-means, mixture models, model-based clustering, density-based spatial clustering of applications with noise (DBSCAN), and OPTICS algorithm), approaches for learning latent variable models such as Expectation-maximization algorithm (EM), method of moments, and blind signal separation techniques (e.g., principal component analysis, independent component analysis, non-negative matrix factorization, singular value decomposition), and anomaly detection (e.g., local outlier factor and isolation forest). Another example type of model is supervised learning that can be used with embodiments of the present disclosure. Example supervised learning models may include different approaches and algorithms including analytical learning, statistical models, artificial neural network (e.g. including convolutional and/or transformer layers) that may have 1-10 layers as examples, recurrent neural network (e.g., long short term memory, LSTM), boosting (meta-algorithm), bootstrap aggregating (bagging) such as random forests, support vector machine (SVM), support vector (SVR), Bayesian statistics, case-based reasoning, decision tree learning, inductive logic programming, linear regression, logistic regression, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), ordinal classification, data pre-processing, handling imbalanced datasets, statistical relational learning, or Proaftn (a multicriteria classification algorithm), or an ensemble of any of these types. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

### BRIEF DESCRIPTION OF THE DRAWINGS

FIG. 1 shows an example item fulfillment system according to embodiments.

FIG. 2 shows a flow diagram illustrating a preparation and delivery method according to embodiments.

FIG. 3 shows a block diagram of a machine learning model according to embodiments.

FIG. 4 shows a method for determining a range of an estimated time of arrival according to embodiments.

FIG. 5 illustrates experimental results of relative improvements in accuracy and consistency of a method according to embodiments.

FIG. 6 shows two distributions with wide and clustered spreads illustrating high and low uncertainties, respectively.

FIG. 7 shows a block diagram of an example computer system usable with systems and methods according to embodiments of the present disclosure.

### DETAILED DESCRIPTION

Many aspects of the delivery process inherently involve uncertainties that can affect the accuracy of estimates. Furthermore, there is a variety of delivery types—ranging from food delivery where a transporter picks up prepared meals, to grocery orders requiring in-store shopping—which introduces distinct delivery dynamics. The estimated time of arrival is also subject to unpredictability due to geographic differences, and external factors. To illustrate, consider the following scenarios:

| Component | Unknown Factor | Potential Impact |
|---|---|---|
| Food Preparation Time | # of sit-down and non | Delay in food |
| | restaurant orders | readiness |
| Dasher Availability | If nearby transporters will | Variability in |
| | accept the order | pickup time |
| Parking Availability | In dense urban areas, finding | Delay in pickup |
| | parking can be a challenge for | and/or drop-off |
| | transporters | |

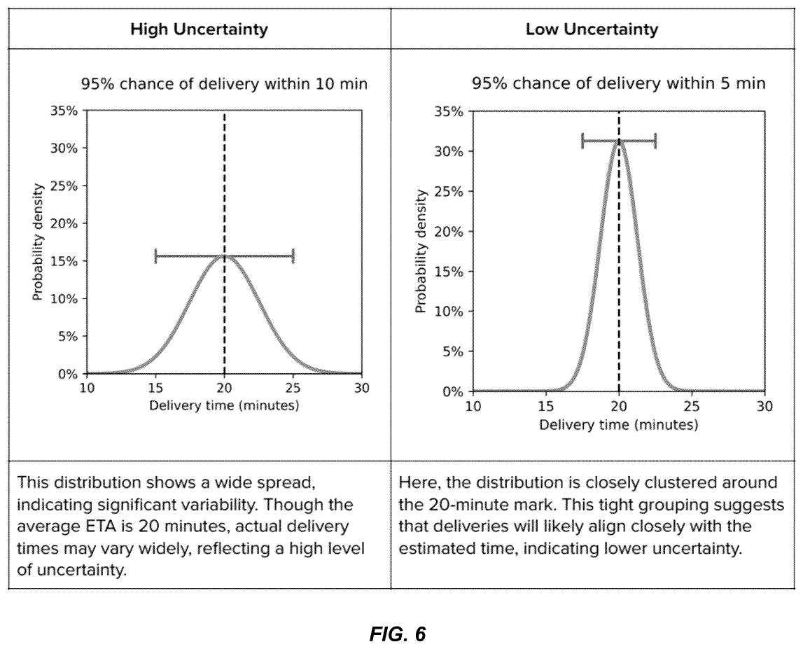

Accuracy can be balanced with other parameters, such as the width of the range. FIG. 6 shows two distributions with wide and clustered spreads illustrating high and low uncertainties, respectively. Both distributions have a predicted ETA of 20 minutes, but the one with the wider spread has a larger variance and a higher chance to be both early and late. These visuals underscore an important concept: understanding the probability of all possible outcomes via a distribution's shape and spread is as crucial as knowing the mean ETA, or most likely arrival time.

It is desired to address these challenges without sacrificing accuracy or precision of ETA estimates. One approach may be to utilize separate models for different delivery scenarios. However, this can lead to inconsistent results across models and a high maintenance burden. Another approach to predicting ETA uses single point estimates (e.g., 10:03 AM). To address uncertainty, heuristic rules can be applied to provide the end user with a time range (e.g., 10:00-10:10 AM). However, this can be inaccurate. Another method involving tree-based models risks performance plateaus because further enhancements, additional features, or more data may not significantly improve outcomes. Tree-based models may also struggle to generalize new or rare scenarios, which limits their effectiveness.

Embodiments of the present disclosure address these and other practical complexities associated with determining an estimated time of arrival associated with an item fulfillment. Embodiments can determine accurate ETA predictions across diverse delivery and service provider scenarios, under changing conditions. A central server computer can receive an item fulfillment request from an end user and use a machine learning model to predict when the item will be delivered to the end user. The central server computer can provide the ETA prediction to the end user at various stages during the item fulfillment process.

There are many factors that impact the arrival time of a delivery, including delivery type (e.g., convenience store or quick service restaurant), the stage of the item fulfillment (e.g., whether or not the user is browsing or checking out), and real-time events (e.g., time of day, transporter availability, traffic). Instead of having multiple independent models for multiple delivery types, which can create inconsistencies in outputs, embodiments can use a consolidated model.

The central server computer can, upon receiving an item fulfillment request from the end user, extract features and use a machine learning model to determine a range of an estimated time of arrival. The machine learning model can include a predictive base layer and a decision layer. The predictive base layer can make accuracy first ETA predictions, and the decision layer can adapt the ETA predictions according characteristics of the item fulfillment request (e.g., pickup or delivery, user engagement stage, item type, etc.).

Advantageously, systems and methods can scale to capture many delivery scenarios. Specific tasks can be addressed via a decision layer, so it is not necessary to spend time and resources building and training separate models for each task. With more computational power available, the machine learning model can process large volumes of high cardinality data. As a result, the machine learning model can provide an enhanced ability to discern and learn from intricate patterns unique to specific data segments. Moreover, since the accuracy predictions from the base prediction layer are decoupled from the decision layer, accuracy is not sacrificed for scalability.

### I. Item Fulfillment System

Accurate ETA predictions can provide effective and efficient delivery experiences among an item fulfillment system. Such an item fulfillment system can include a delivery platform which coordinates transporters to retrieve items from service providers and make deliveries to end users.

### A. System Overview

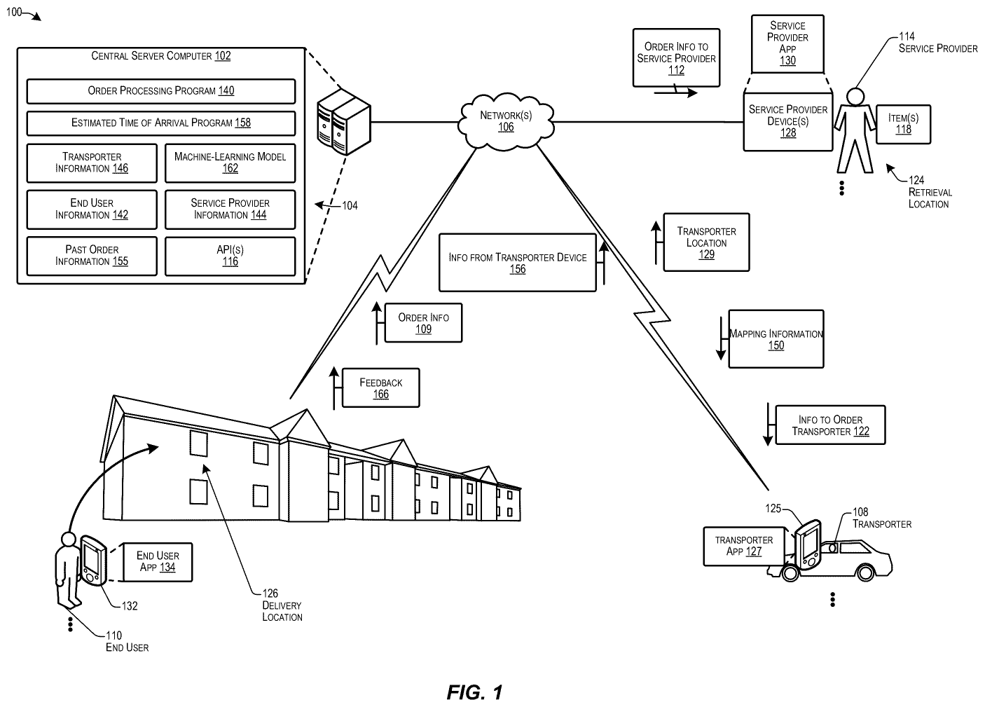

FIG. 1 illustrates an example item fulfillment system 100 measuring variety of information (e.g., delivery time, number of orders per end user, etc.) according to some implementations. For instance, the system 100 may enable one or more central server computers 102 associated with a delivery platform 104 to measure delivery information received over one or more networks 106 from one or more transporters 108.

Some example implementations are described in the environment of one or more central server computers 102 that manage a network of transporters 108 to coordinate deliveries and provide estimated times of arrival for the deliveries. However, implementations herein are not limited to the particular examples provided, and may be extended to other service environments, other system architectures, other types of transporters, other types of deliveries, other types of mapping information, and so forth, as will be apparent to those of skill in the art in light of the disclosure herein.

In the illustrated example, the central server computer 102 may be configured to service, over the one or more networks 106, an item fulfillment request comprising order information 109 from an end user 110. While one transporter 108, one end user 110, and one service provider 114 are shown in this example for clarity of illustration, a large number of transporters 108, end users 110, and service providers 114 may individually participate in the system 100. As examples, an item fulfillment request system can include at least 10, 100, 1,000, 5,000, 10,000, 50,000, or 100,000 transporters devices, end user devices, and service provider computers. Moreover, various numbers of communication messages (e.g., item fulfillment requests, ETA predictions) may be exchanged between devices, including at least 100, 200, 500, 1,000, 10,000, 50,000, 100,000, 500,00, or one million communication messages within a time constraint of 30 seconds, 1 minute, 10 minutes, 30 minutes, 1 hour, 4 hours, 1 day, or 7 days.

As the end user 110 browses for an item or places an order for an item, the central server computer 102 can obtain retrieval information (e.g., a retrieval location for the item) and transporter information (e.g., a number of available transporters in a nearby area) to calculate an estimated time of arrival for the item. The end user 110 can complete checkout and submit an item fulfillment request comprising the order information 109 to the central server computer 102. The order information 109 may include an indication of an item, and an indication of a delivery location. The delivery location may be explicitly specified with the order information or, alternatively, may be implied to be a default delivery location already associated with an end user account of the end user 110. The item may be associated with a retrieval location (e.g., a service provider location to pick up the item from) or may be determined based on whichever service provider agrees to provide the indicated item.

Based on the order information 109 received from the end user 110, the central server computer 102 may send order information 112 to at least one particular service provider 114 of a plurality of service providers that will provide a requested item 118. The particular service provider 114 may receive the order information 112, and may respond with a confirmation to confirm that the request for the item 118 has been received and the item 118 will be provided by the service provider 114.

The central server computer 102 can coordinate a transporter 108 to pick up the item from a retrieval location 124 and deliver it to the end user 110 at the delivery location. In response to receiving the confirmation from the particular service provider 114, the central server computer 102 may send order information 122 to a transporter user device 125 of a selected transporter 108 who, upon accepting the delivery job, will pick up the order from the service provider 114 at the retrieval location 124 and deliver the order to the end user 110. The order information 122 sent to the transporter user device 125 may include item information, the retrieval location 124 for the order, the pickup time, the delivery location 126, and a delivery time for the order.

In the illustrated example, the central server computer 102 of the delivery platform 104 is able to communicate with the transporter user device 125 over the one or more networks 106. Each transporter 108 may be associated with a respective transporter user device 125 that may execute a respective instance of a transporter application 127. For example, the transporters 108 may use transporter user devices 125, such as smart phones, tablet computers, wearable computing devices, laptops, or the like, as further enumerated elsewhere herein, and these transporter user devices 125 may have installed thereon the transporter application 127. The transporter application 127 may be configured to receive the order information 122 from the central server computer 102 to provide a particular transporter 108 with information for picking up a particular order from a service provider's pickup location 124 and for delivering the order to a end user's delivery location 126. The transporter application 127 may further enable the transporter 108 to respond to the central server computer 102 to confirm acceptance of a delivery job.

Additionally, in some cases, the transporter application 127 may provide the central server computer 102 with an indication of a current transporter location 129 of a particular transporter 108. For example, the transporter application 127 may obtain the current location from a GPS receiver (not shown in FIG. 1) included onboard the transporter user device 125. As mentioned above, the term “GPS” as used herein may include any global navigation satellite system (GNSS) such as the Global Positioning Satellite (GPS) system, the Russian Global Navigation Satellite System (GLONASS), the Chinese BeiDou Navigation Satellite System (BDS), the European Union's Galileo system, the Japanese Quasi-Zenith Satellite System (QZSS), the Indian Regional Navigation Satellite System (IRNSS), any other satellite-based location positioning system, or any similar such system for providing accurate indications of current location to a mobile device. Accordingly the GPS receiver herein may be able to determine the location 129 (e.g., latitude and longitude) of the transporter user device 125 based on received signals from one or more satellite positioning systems or the like. Additionally, in some examples, the transporter application 127 and the central server computer 102 may communicate with each other via one or more application programming interfaces (APIs) 116.

Each service provider computer 128 may be associated with a respective resource provider 114. Each service provider computer 128 may be a computing device, such as a desktop, laptop, tablet, smart phone, or the like, and may include a respective instance of a service provider application 130 that executes on the respective service provider computer 128. For example, the service provider application 130 may be configured to communicate with the central server computer 102, such as for receiving the order information 112 and for sending a confirmation. In some examples, the service provider application 130 and the central server computer 102 may communicate with each other via one or more APIs 116

In addition, the end users 110 may be associated with respective end user devices 132 that may execute respective instances of a end user application 134. For example, the end users 110 may use the end user devices 132, such as smart phones, tablet computers, wearable computing devices, laptops, desktops, or the like, and these end user devices 132 may have installed thereon or may otherwise access the end user application 134. The end user application 134 may enable the end users 110 to select one or more items 118 to purchase from one or more of the service providers 114 to be delivered to the end user 110 by one or more of the transporters 108. For example, the end user application 134 may present one or more UIs on a display of the end user device 132 for enabling the end user 110 to select one or more items 118 for an order. In some examples, the end user application 134 and the central server computer 102 may communicate with each other via one or more APIs 116. Additionally, or alternatively, the end user application 134 may be a browser, or the like, and the end user 110 may navigate to a website or load a web application associated with the delivery platform 104, and may use the website or web application received from the central server computer 102 to place an order.

The one or more networks 106 can include any appropriate network, including a wide area network, such as the Internet; a local area network, such an intranet; a wireless network, such as a cellular network, a local wireless network, such as Wi-Fi and/or close-range wireless communications, such as BLUETOOTH®; a wired network; or any other such network, or any combination thereof. Accordingly, the one or more networks 106 may include both wired and/or wireless communication technologies. Components used for such communications can depend at least in part upon the type of network, the environment selected, or both. Protocols for communicating over such networks are well known and will not be discussed herein in detail. Accordingly, the central server computer 102, the service provider computer(s) 128, the end user device(s) 132, and/or the transporter user device(s) 125 are able to communicate over the one or more networks 106 using wired or wireless connections and combinations thereof.

In the illustrated example, the central server computer 102 includes an order processing program 140 that may be executed on the central server computer 102 to provide, at least in part, the functionality attributed to the central server computer 102. The order processing program 140 may receive the order information 109 from the end user 110 and may associate the order information 109 with end user information 142 and service provider information 144. For instance, based on end user identifying information that may be included with the order information 109, the order processing program 140 may associate particular order information 109 with a particular end user account. Further, based on a particular service provider 114 identified by the order information 109, the order processing program 140 may associate the order information 109 with a service provider account of a particular service provider 114 to send the order information 112 to the service provider 114.

In addition, as the end user selects items to order and checks out, the order processing program 140 may receive the order information 109 and transporter data 146 and may provide this received information to an estimated time of arrival program 158 that may be executed on the one or more central server computers 102. For example, the estimated time of arrival program 158 may determine a retrieval location based on the order information 109 and transporter information based on the transporter data 146 of each transporter 108. The received information may be input to a machine learning model 162.

The machine learning model 162 may be executed to determine a range of an estimated times of arrival of the item 118. For instance, the machine-learning model 162 may be trained to account for pieces of information included in the order information 109 and transporter information 146. In some cases, the machine-learning model may be initially trained using a set of training data. For example, the machine-learning model 162 may be trained using training data that includes a large number of past orders included in the past order information 155. The trained machine learning model 162 may be checked for accuracy using another portion of past order information 155, and may then be deployed for use in determining a range of an estimated time of arrival. The machine-learning model 162 may be periodically updated and re-trained based on new training data to keep the machine-learning model 162 up to date and accurate.

The estimated time of arrival program 158 may obtain the range of estimated time of arrival from of the machine learning model 162 and provide it to the end user 110 throughout ordering and delivery. The range of an estimated time of arrival can be a range of durations (e.g., 35-40 minutes) or a range of arrival times (e.g, 5:00 pm-5:15 pm).

In addition, the order processing program 140 may access transporter data 146 to determine transporter contact information for sending the order information 122 to a particular transporter 108 to determine whether the particular transporter 108 is willing to accept the delivery job of delivering the order to the end user 110. The particular transporter 108 may use the transporter application 127 on the transporter user device 125 to receive a message with information about the order, and to respond with acceptance of the delivery job if the job is accepted. The particular transporter 108 may subsequently pick up the order from the particular service provider 114 and deliver the order to the particular end user 110 at a specified delivery location 126.

When the transporter 108 has completed delivery of the order to the delivery location 126, the transporter 108 may use the transporter application 127 to inform the order processing program 140 that the delivery has been completed. Upon receiving the indication of completion, the order processing program 140 may store information related to the order and completion of the order as past order information 155.

Throughout the process of delivery, all the measurements (e.g., location, delivery time, order information, etc.) are sent to the central server computer 102. The central server computer 102 can store these measurements and later perform the experimental analysis to improve different fields such as shortening delivery time, increasing number of orders per end user, etc.

### B. Item Fulfillment Process

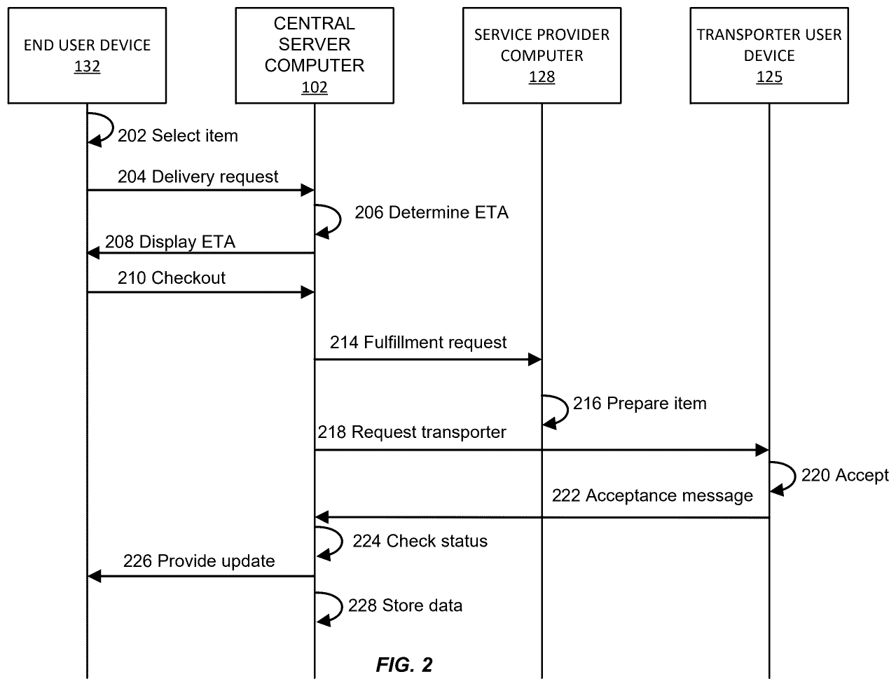

FIG. 2 shows a flow diagram illustrating a preparation and delivery method according to embodiments. The method 200 illustrated in FIG. 2 will be described in the context of the item fulfillment system 100 of FIG. 1. A central server computer 102 receiving a fulfillment request message from the end user device 132 can fulfill preparation and delivery of one or more items from a cart to the end user of the end user device 132. The central server computer 102 can communicate with the service provider computer 128 and the transporter user device 125 to fulfill the fulfillment request.

At step 202, the end user can engage with a central server computer application installed on the end user device 132 to request an item for delivery. For example, a delivery platform may provide an online website that identifies items from multiple service providers that are available for delivery by the delivery platform. The end user may navigate to the online site, select a service provider, and browse for an item for delivery. The end user device 132 can transmit a request to the central server computer 102. The request can comprise end user information such as a delivery location and service provider information such as a retrieval location.

At step 204, after receiving the request from the end user device 132, the central server computer 102 can obtain feature information. If it was not included in the request, the central server computer 102 can determine the retrieval location according to the order information in the request. For example, the retrieval location may be associated with the service provider closest to the delivery location with the item available. The central server computer 102 may additionally retrieve transporter data from each transporter device 108 that is currently active for the retrieval location. The central server computer 102 can determine transporter information based on the received transporter data, such as a number of available transporters within a radius of the retrieval location.

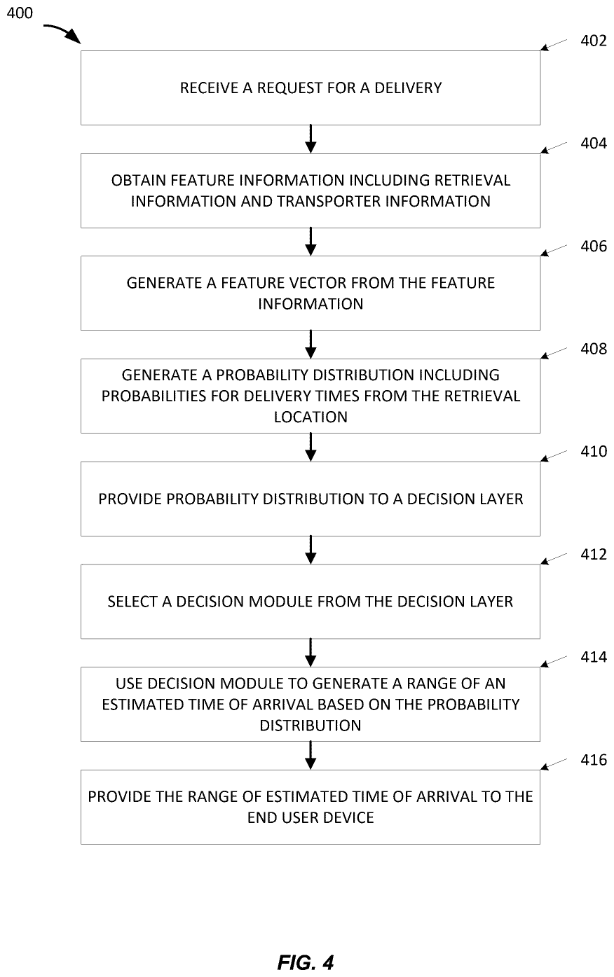

At step 206, after obtaining the feature information, the central server computer 102 can determine a feature vector using the feature information. The central server computer 102 can use the feature vector as input to a machine learning model to determine a range of estimated time of arrival, and provide it to the end user device 132. This method is described in detail below with reference to FIG. 4.

At step 208, after receiving the range of estimated time of arrival from the central server computer 102, the end user device 132 can display the range of estimated time of arrival to the end user. The estimated time of arrival can influence the end user's decision to check out. For example, the end user may be inclined to request delivery for an item from the service provider because fast delivery is predicted. The end user can decide to check out with a cart in a delivery platform application installed on the end user device 132. The cart can include one or more items that are provided from a service provider of the service provider computer 128.

At step 210, after initiating checking out with the cart, the end user device 132 can provide a fulfillment request message including order information to the central server computer 102. The order information can include the one or more selected items, and optionally a service provider identifier that identifies the service provider computer 128. The central server computer 102 can perform a transaction process with the end user device 132. For example, the central server computer 102 can communicate with a payment network to process the transaction for the one or more items. The central server computer 102 can receive an indication of whether or not the transaction is authorized. If the transaction is authorized, then the central server computer 102 can proceed with step 214.

At step 214, the central server computer 102 can provide the fulfillment request message, or a derivation thereof, to the service provider computer 128. The central server computer 102 can determine which service provider computer of a plurality of service provider computers to communicate with based on the service provider indicated in the fulfillment request message. For example, the central server computer 102 can determine that the one or more items in the fulfillment request are provided by the service provider of the service provider computer 128. If the item fulfillment request includes a service provider computer identifier, the central server computer 102 can identify the service provider computer 128 using the service provider computer identifier in the fulfillment request message.

At step 216, after receiving the fulfillment request message, the service provider computer 128 can initiate preparation of the one or more items. For example, the service provider computer 128 can alert service providers (e.g., those preparing the items) at the service provider location. The service providers can prepare the one or more items for pick up by a transporter.

At step 218, after providing the fulfillment request message to the service provider computer 128, the central server computer 102 can determine one or more transporters operating one or more user devices that are capable of fulfilling the fulfillment request message, and provide the fulfillment request message, or a derivation thereof, to the one or more transporter user devices including the transporter user device 125. The central server computer 102 can determine the one or more transporters from the transporter user devices. The central server computer 102 can determine the one or more transporter user devices based on whether or not the transporter user device is online, whether or not the transporter user device is already fulfilling a different fulfillment request message, a location of the transporter user device, etc.

At step 220, after receiving the fulfillment request message, the transporter of the transporter user device 125 can determine whether or not they want to perform the fulfillment. The transporter can decide that they want to perform the delivery of the one or more items from the retrieval location to the delivery location. The transporter user device 125 can generate an acceptance message that indicates that the fulfillment request is accepted.

At step 222, after generating the acceptance message, the transporter user device 125 can provide the acceptance message to the central server computer 102.

After providing the acceptance message to the central server computer 102, the transporter user device 125 can communicate with the navigation network and the transporter can proceed to the retrieval location to obtain the one or more items. The transporter user device 125 can then receive input from the transporter that indicates that the transporter obtained the one or more items (e.g., the transporter selects that they picked up the items). The transporter user device 125 can then communicate with the navigation network and the transporter can then proceed to the delivery location to provide the one or more items to the end user. In some embodiments, the transporter user device 125 can provide update messages to the central server computer 102 that include a transporter user device 125 location and/or event data (e.g., items picked up, items delivered, etc.).

In some embodiments, after receiving the acceptance message, the central server computer 102 can notify the other transporter user devices that received the fulfillment request message that the fulfillment request is no longer available.

At step 224, at any point after receiving the acceptance message, the central server computer 102 can check the status of the fulfillment request. For example, the central server computer 102 can determine the location of the transporter user device 125 and can determine an estimated amount of time for the transporter user device 125 to arrive at the end user location.

At step 226, the central server computer 102 can provide an update message to the end user device 132 that includes data related to the fulfillment of the fulfillment request message. The data can include an estimated amount of time, the transporter user device location, event data (e.g., items picked up from the service provider), and/or other data related to the fulfillment of the fulfillment request message.

At step 228, the central server computer 102 can store any data received, sent, and/or processed during the fulfillment of the fulfillment request message into a database. For example, the central server computer 102 can store a user's cart selection as user features into a user feature database.

### II. Arrival Time Estimation

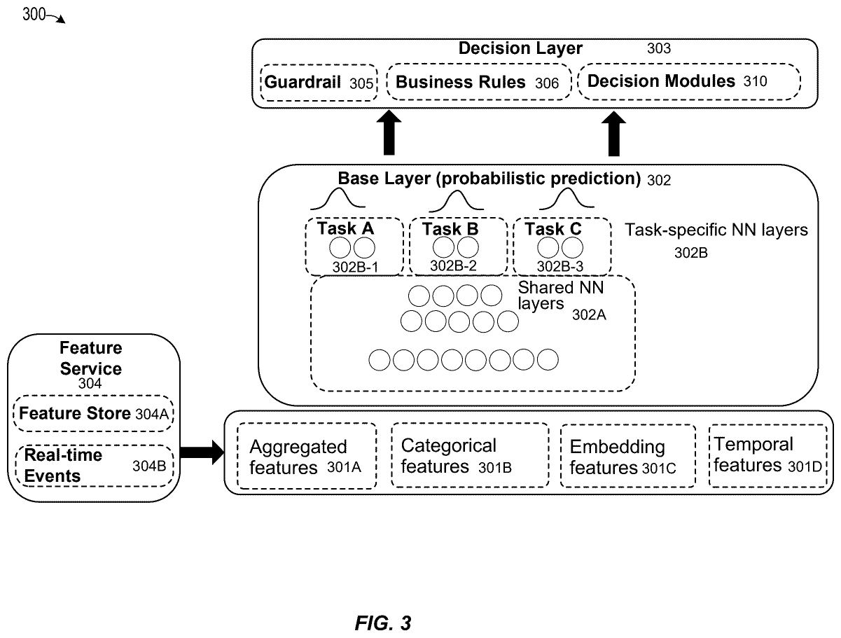

A central server computer in an item fulfillment system can estimate the time of arrival, and may provide the estimates to the end user at various stages during delivery. As described above, the end user may receive a range of an estimated time of arrival (ETA) from the central server computer after selecting an item and begin to check out. Additionally, the central server computer may provide the estimates prior to checkout as the user browses for an item. The central server computer can use a machine learning model to determine the range of an estimated time of arrival. FIGS. 3-4 include these systems and methods.

### A. Machine Learning Model

Depending on the delivery type and when the request is received from the user, different feature information may be available in an item fulfillment request. However, training separate models for multiple categories of item fulfillment requests is not scalable and can provide inaccurate estimates. Embodiments can provide a machine learning model that can enable streamlined ETA predictions across different stages of end user engagement and a variety of delivery types within a singular, adaptable framework. The machine learning model can adapt to diverse scenarios and learn complex relationships from embeddings and time series data to capture temporal and spatial patterns.

FIG. 3 shows a block diagram of a machine learning model 300 according to embodiments. FIG. 3 shows a feature service 304 and a machine learning model 300 comprising a base prediction layer 302 and a decision layer 303. The machine learning model 300 can comprise a two-layer structure which decouples the decision layer 303 from the base prediction layer 302.

The machine learning model 300 may be used for generating a range of estimated time of arrival for an item fulfillment request. For example, using the machine learning model, a central server computer can generate a range of estimated arrival time of a transporter. The central server computer may provide the range of estimated arrival time to an item fulfillment system.

The feature service 304 can provide feature information during model execution. A feature store 304A can compute the feature values according to feature definitions and collected data (e.g., from a database of historical item fulfillment requests, from online events). The calculated feature information may be stored in a database for retrieval during model execution. Additionally, the feature service 304 can use dynamic data from real time events 304B, which provides information related to the status of the item fulfillment system such as how many requests have been retrieved from a particular retrieval location, how many transporters are currently at a particular retrieval location, etc.

The feature information may include parameters from an item fulfillment request, such as aggregated features 301A (e.g., average delivery time to pick up time, average prep time), categorical features 301B (e.g., pick-up and drop-off locations in various granularities, store type), embedding features 301C (e.g., time of day, quantiles of travel time), and temporal features 301D (e.g., order volume per minute over the past 30 minutes).

The machine learning model 300 can encode feature information into a feature vector. The machine learning model 300 can include various input parameters. As examples, the feature vector can include at least 5, 10, 50, 100, 500, 1,000, 5,000 features.

Some features may be task-specific. That is, some feature data may be unavailable for a current item fulfillment request. For example, an item fulfillment request from a user browsing a homepage may lack a number of items and subtotal. When such data is not available, the task-specific features may be satisfied with default values. The default values can include, for example, historical averages such as a historical average number of items and a historical average subtotal.

The machine learning model 300 can include two layers: a decision layer 303 and a base prediction layer 302. In the base prediction layer 302, shared neural network layers 302A can learn generalized representations of shared feature information, while task-specific neural network layers 302B can generate predictions according to multiple tasks.

Features from an item fulfillment request may be encoded into a feature vector, and input to the shared neural network layers 302A. Sparse variables (variables with high cardinality) can be embedded to meaningful vector representations. As an example, feature information may be input to various computational layers and weighted according to trained parameters.

Shared features can include features that are always present. For example, store level average pick up time, delivery time, and preparation time may be shared features. Task-specific features, in contrast, may vary across item fulfillment requests. For example, cart-related features (e.g., item subtotal, number of items, etc.) may be task-specific features for a decoder A that determines checkout page ETAs. Such features may be unknown for other tasks, such as a decoder B that determines service provider page ETAs prior to the end user selecting items for delivery.

To illustrate further, there may be two stages of end user engagement when placing an order: an explore stage and a checkout stage. The explore stage can be when the end user browses through stores without selecting any items yet. At this stage, the central server computer 102 can only access features related to store or end user historical behavior. In comparison, in the checkout stage, the end user has selected one or more items, so item information is available.

Although the two tasks have many features in common, with labels—actual delivery duration—shared between both, the availability of order information can be different for some real-time information. Training individual models to support these two stages has been found to lead to estimation inconsistencies. For example, if the ETA prediction displayed to the end user on an explore page is inconsistent with the ETA prediction displayed during checkout, it may confuse the end user.

Instead of having independent models for different tasks (e.g., one for generating an ETA when an end user has no items in their cart and the other for when the end user is checking out), the base prediction layer 302 can comprise separate decoders within a consolidated model. For example, the task-specific neural network layers 302B can include three decoders 302B-1, 302B-2, and 302B-3 to address tasks A, B, and C. The task-specific decoders can handle the input difference and convert a final encoded representation into an output prediction. In this way, the feature vector (e.g., from the shared neural network layers 302A) can be “decoded” according to the task or delivery type (e.g., determining ETA when there are no items selected vs during checkout).

Each decoder may output a probability distribution representing probabilities of delivery times from the retrieval location for a specific task. For example, the probability distribution can include a plurality of delivery times, each weighted by a probability. The probability distribution can include a single delivery time with the highest probability (e.g., 30 minutes) and an uncertainty (e.g., +/−10 minutes).

When an item fulfillment request is received, the machine learning model may receive a task flag which indicates which decoder output should be used. For example, if the end user has made a selection of an item, a task flag associated with a checkout decoder may be transmitted to the machine learning model. The machine learning model 300 can determine which probability distribution is appropriate use for the current task based on the task flag. The determined probability distribution can be passed to the decision layer 303 to be refined.

The decision layer 303 can leverage the output from the base prediction layer 302 to solve various multi-objective optimization problems. This structure enables the machine learning model 300 to accommodate a diverse set of objectives, each with its own priority. Rather than training multiple models to address a variety of tasks, new objectives can be onboarded and fine tuned on top of the base prediction layer 302.

The decision layer can comprise a plurality of decision modules 310 for solving various multi-objective optimization problems according to different retrieval locations. The decision modules 310 may optimize parameters such as the range (e.g., minimize the range) and accuracy (e.g., maximize the accuracy). The decision module to invoked may be selected based on the retrieval location or type of retrieval location that the item fulfillment request is for. For example, each decision module 310 may be associated with a retrieval location or type of retrieval location, and may incorporate the preferences of the retrieval location or type of retrieval location. In various embodiments, the decision modules may be machine learning models.

This allows the service provider associated with the retrieval location to specify parameters to prioritize in ETA calculations. For example, embodiments can accommodate for a service provider that wishes to overpredict ETA to avoid lateness using an objective function that adjusts the ETA prediction by adding a buffer to the range.

Other parameters that the decision layer modules may consider can include width of the distribution, which is associated with uncertainty, and accuracy of the distribution. To illustrate, a range of an estimated time of arrival of 0-100 minutes may capture every possible arrival time, but would not be useful to end users. The balancing of accuracy and range width can vary for different delivery categories. For example, a wider range may be acceptable when the total delivery time is long. A 20 minute window for a 30 minute delivery (e.g., 10-50 minutes) is less desirable than a 20 minute window for a 120 minute delivery (e.g., 100-140 minutes).

Generally, in balancing precision and accuracy, it may be desired to minimize the width of the range of estimated arrival times while also maximizing the percent of the probability distribution that is within the range of estimated arrival times. As an illustration, when the cumulative distribution function has a “long-tail,” there may be a high chance that the ETA is far from the most likely ETA. For example, for an item fulfillment, the most likely ETA may be within 20 minutes, but there may also be a high probability that the item arrives in an hour. Different retrieval locations may have different priorities; a first retrieval location may prefer to have a wide range of ETA to avoid lateness, while a second retrieval location may prefer to risk lateness in order to reduce ETA uncertainty. The decision layer 303 can be responsible for evaluating accordingly.

Guardrails 305 may be set to constrain outputs according to hard-coded parameters. As an example, a decision module may include guardrails 305 to ensure the lower bound of the range to be higher than 30 minutes, and the upper bound of the range to be less than two hours. Another guardrail may refine the range width according to the upper bound, for example, it may ensure the range width be less than or equal than 10 minutes if the upper bound is less than 1 hour.

A decision module may additionally implement business rules 306 associated with the retrieval location or type of retrieval location to constrain ETAs. For example, a resource provider of the associated retrieval location may require at least 20 minutes to prepare items. Thus, a business rule 306 can be set so ETAs for the associated retrieval location are no less than 20 minutes.

### B. Determination of Estimated Time of Arrival

FIG. 4 shows a method 400 for determining a range of estimated time of arrival during the processing of an item fulfillment request. The method 400 can be described in the context of a central server computer determining a range of estimated time of arrival for a delivery of an item from a service provider to an end user. The central server computer can include the machine learning model 300 of FIG. 3.

At step 402, a central server computer can receive an item fulfillment request from an end user device operated by an end user. The end user of the end user device may be attempting to request delivery of an item from a resource provider. The method 400 may be initiated at various stages of end user engagement. For example, the item fulfillment request may be initiated as the end user browses a home page to select a resource provider, as the user browses a resource provider page to select an item, or after the user selects the item and is checking out.

At step 404, the server computer can obtain feature information including (1) retrieval information and (2) transporter information. The retrieval information be associated with a potential service provider from which the end user may request an item from. For example, the retrieval information can include a location that a transporter retrieves the item to be delivered (e.g., service provider storefront), and an availability of the potential service provider. The transporter information may be associated with a plurality of transporter devices operated by a plurality of available transporters that are currently active for the retrieval location (e.g., data associated with transporters at or near the retrieval location).

Other example features may include shared features such as a time of day, a number of available transporters, a historical arrival time associated with the retrieval location, and task-specific features such as a number of items, a total value, etc.

At step 406, after obtaining the feature information, the central server computer can generate a feature vector from the feature information. For example, the central server computer can encode the feature information and convert it into a feature vector.

If feature information is unavailable for the present task, a default value can be used in place of the unavailable feature(s). Examples of default values can include historical averages. For example, the number of items may be unavailable in an item fulfillment request for an end user who is scrolling a home page and has not yet selected any items. A historical average number of items ordered by the end user can be used instead.

At step 408, the central server computer can use the machine learning model to generate a probability distribution representing probabilities for delivery times from the retrieval location. The probability distribution may include a most probable delivery time (e.g., 30 minutes), and a an uncertainty (e.g., +/−10 minutes). In some embodiments, the probability distribution can be determined according to a predetermined formula, or using sampling.

In various embodiments, the machine learning model may output a plurality of probability distributions according to different tasks. For example, the central server computer can input the feature vector to task specific decoders. The different tasks may include different fulfillment request categories (e.g., pickup or delivery) and end user engagement stages (e.g., explore page, checkout page). The machine learning model can select the probability distribution from the decoder for the current task. For example, the machine learning model may receive a task flag associated with the lack of a selection by the end user which indicates that the end user engagement is during an explore page. The machine learning model can use the probability distribution from an explore page decoder.

At step 410, the central server computer can provide the probability distribution (e.g., output of the probabilistic base layer) to a decision layer that includes a plurality of decision modules associated with different retrieval locations or types of retrieval locations, wherein the retrieval information includes an identifier corresponding to the retrieval location or a type of the retrieval location. The plurality of decision modules can include parameters which determine how to optimize ETA for different retrieval locations and types of retrieval locations. In various embodiments, the decision layer may include the decision layer 303 of FIG. 3.

At step 412, the server computer can select a decision module based upon the identifier corresponding to the retrieval location or the type of retrieval location. For example, the decision layer can include a decision module for convenience stores, grocery stores, quick service restaurants, retail stores, and dine-in restaurants. The central server computer can determine that the retrieval information includes an identifier for a convenience store, and can select the decision module for convenience stores.

At step 414, the decision module can generate a range of an estimated time of arrival of the transporter based on the probability distribution. The range of estimated time of arrival can be determined according to several parameters such as range width and accuracy. Furthermore, guardrails such as maximum and minimum range width may also be used to cater to specific delivery scenarios.

Different retrieval locations and types of retrieval locations may have different preferences for how the ETA is optimized. For example, some service providers may wish to overpredict ETA (e.g., predict a longer wait time) to minimize lateness so that the user is not unsatisfied. Thus, the parameters and guard rails in the selected decision module can optimize ETA subject to the preferences retrieval location or type of retrieval location.

At step 416, the server computer can provide to the end user device the range of an estimated time of arrival, and store any data received, sent, and/or processed during the fulfillment of the fulfillment request message into a database. The end user device can display the range of an estimated time of arrival to the end user via a delivery platform application.

### III. Experimental Results

To holistically assess the machine learning model, a unified metric that can compare different models effectively is needed. Model performance can be evaluated according to Continuous Ranked Probability Score (CRPS). CRPS measures how well the predicted distribution (every point weighted by its probability) aligns with the actual observed delivery time. CRPS extends the concept of Mean Absolute Error (MAE) to probabilistic forecasts. The formula for CRPS is:

$$CRPS ( F ( \cdot \vert X ) , x ) = {\int }_{- ∞}^{∞} {( F ( y \vert X ) - 1 \{ y \geq x \} )}^{2} d y$$

Where
F (y|X) represents the cumulative distribution function (CDF) of the forecast, conditioned on the covariates X.
x is the single observed delivery time for an order
1{y≥x} is the indicator function, equal to 1 if y≥x and 0 otherwise

By averaging the CRPS across multiple predictions, a single, comparable score can be derived. This score is crucial for identifying areas where our model excels and where it needs refinement, ensuring continuous improvement in our ETA predictions.

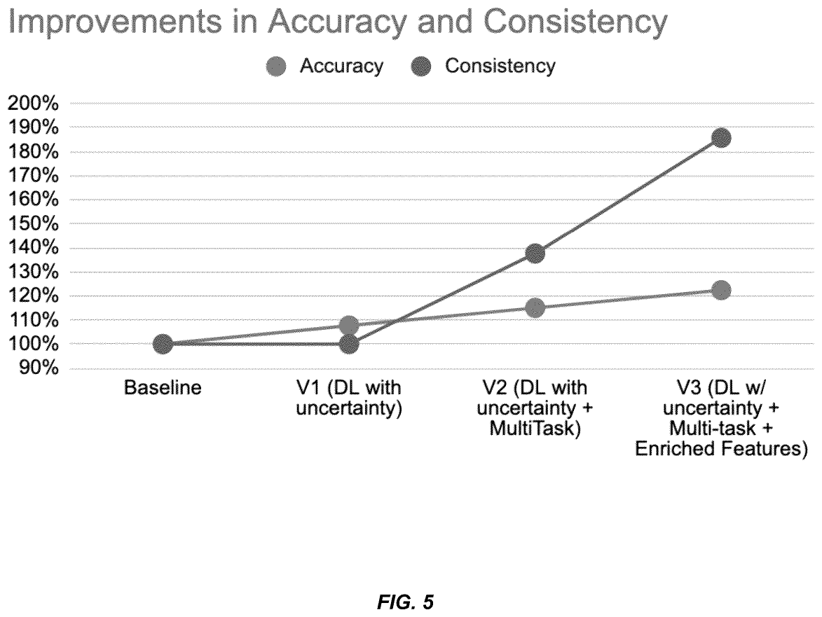

FIG. 5 illustrates experimental results of relative improvements in accuracy and consistency of three machine learning models according to embodiments. FIG. 5 sets the baseline as 100% and shows the relative improvements in accuracy and consistency of three models: V1, V2, and V3. For example, compared with baseline, incorporating a machine learning model with a decision layer, a multi-task architecture, and enriched features (V3) improves the ETA accuracy by over 20% and boosts consistency by more than 80%.

Embodiments of the present disclosure have a number of technical advantages. By embracing advanced predictive modeling with multi-task models, deep learning, and probabilistic forecasts embodiments can produce accurate and consistent forecasts while accounting for real-world uncertainties, various delivery conditions, at different stages of end user engagement. Under-predictions and over-predictions are reduced and the end user experience is enhanced. Moreover, embodiments provide a scalable model which can accommodate large volumes of high dimensional data. The multi-task model architecture enables learning transfer between different tasks, and shared features simplify development and reduce velocity.

### IV. Computer System

Any of the computer systems mentioned herein may utilize any suitable number of subsystems. Examples of such subsystems are shown in FIG. 6 in computer system 10. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

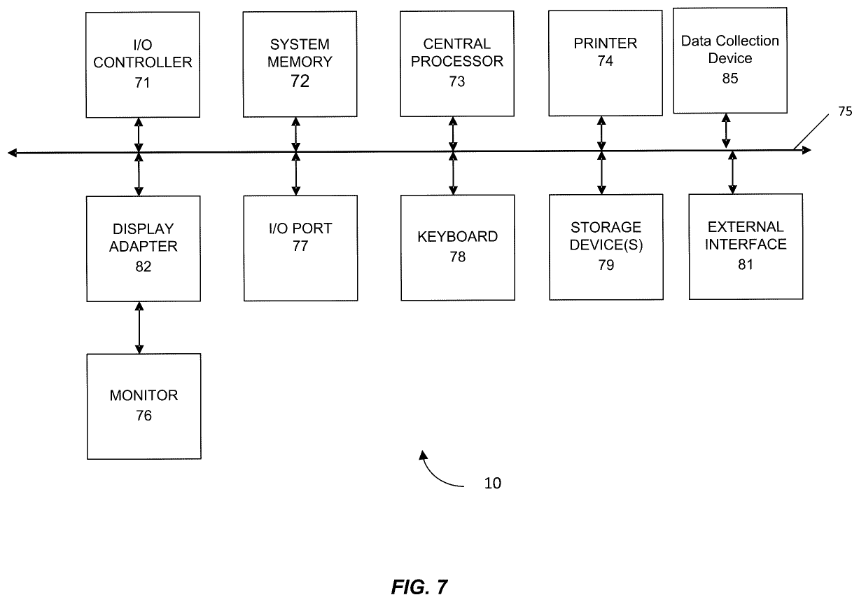

The subsystems shown in FIG. 7 are interconnected via a system bus 75. Additional subsystems such as a printer 74, keyboard 78, storage device(s) 79, monitor 76 (e.g., a display screen, such as an LED), which is coupled to display adapter 82, and others are shown. Peripherals and input/output (I/O) devices, which couple to I/O controller 71, can be connected to the computer system by any number of means known in the art such as input/output (I/O) port 77 (e.g., USB, FireWire®). For example, I/O port 77 or external interface 81 (e.g., Ethernet, Wi-Fi, etc.) can be used to connect computer system 10 to a wide area network such as the Internet, a mouse input device, or a scanner. The interconnection via system bus 75 allows the central processor 73 to communicate with each subsystem and to control the execution of a plurality of instructions from system memory 72 or the storage device(s) 79 (e.g., a fixed disk, such as a hard drive, or optical disk), as well as the exchange of information between subsystems. The system memory 72 and/or the storage device(s) 79 may embody a computer readable medium. Another subsystem is a data collection device 85, such as a camera, microphone, accelerometer, and the like. Any of the data mentioned herein can be output from one component to another component and can be output to the user.

A computer system can include a plurality of the same components or subsystems, e.g., connected together by external interface 81, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components. In various embodiments, methods may involve various numbers of clients and/or servers, including at least 10, 20, 50, 100, 200, 500, 1,000, or 10,000 devices. Methods can include various numbers of communication messages between devices, including at least 100, 200, 500, 1,000, 10,000, 50,000, 100,000, 500,00, or one million communication messages. Such communications can involve at least 1 MB, 10 MB, 100 MB, 1 GB, 10 GB, or 100 GB of data.

Aspects of embodiments can be implemented in the form of control logic using hardware circuitry (e.g., an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer readable medium may be any combination of such devices. In addition, the order of operations may be re-arranged. A process can be terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Any operations performed with a processor (e.g., aligning, determining, comparing, computing, calculating) may be performed in real-time. The term “real-time” may refer to computing operations or processes that are completed within a certain time constraint. The time constraint may be 1 minute, 1 hour, 1 day, or 7 days. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

The specific details of particular embodiments may be combined in any suitable manner without departing from the spirit and scope of embodiments of the disclosure. However, other embodiments of the disclosure may be directed to specific embodiments relating to each individual aspect, or specific combinations of these individual aspects.

The above description of example embodiments of the present disclosure has been presented for the purposes of illustration and description. It is not intended to be exhaustive or to limit the disclosure to the precise form described, and many modifications and variations are possible in light of the teaching above.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

The claims may be drafted to exclude any element which may be optional. As such, this statement is intended to serve as antecedent basis for use of such exclusive terminology as “solely”, “only”, and the like in connection with the recitation of claim elements, or the use of a “negative” limitation.

All patents, patent applications, publications, and descriptions mentioned herein are incorporated by reference in their entirety for all purposes. None is admitted to be prior art. Where a conflict exists between the instant application and a reference provided herein, the instant application shall dominate.

What is claimed is:

1. A computer-implemented method comprising:
receiving, from an end user device, a request for a delivery;
obtaining feature information including (1) retrieval information associated with a retrieval location from which an item is to be delivered by a transporter and (2) transporter information associated with a plurality of transporter devices of transporters that are currently active for the retrieval location;
generating a feature vector from the feature information;
generating, using a machine learning model and the feature vector, a probability distribution representing probabilities for delivery times from the retrieval location;
providing the probability distribution to a decision layer that includes a plurality of decision modules associated with different retrieval locations or types of retrieval locations, wherein the retrieval information includes an identifier corresponding to the retrieval location or a type of the retrieval location;
selecting a decision module corresponding to the identifier;
generating, by the decision module, a range of an estimated time of arrival of the transporter based on the probability distribution; and
providing, to the end user device, the range of an estimated time of arrival.

2. The method of claim 1, wherein the item has not been selected before receiving the request.

3. The method of claim 1, wherein the probability distribution includes (1) a single delivery time with the highest probability and (2) an uncertainty.

4. The method of claim 1, wherein the machine learning model incudes a plurality of decoders, wherein each decoder is associated with a different task, and wherein a task flag is provided to the machine learning model based on a selection or lack of selection in a user interface by the end user device.

5 .The method of claim 4, wherein the plurality of decoders comprise a resource provider page decoder and a home page decoder.

6. The method of claim 1, wherein generating the feature vector comprises:
encoding, using the machine learning model, (1) shared features and (2) task-specific features associated with the task flag; and
determining default values for task-specific features that are not associated with the task flag.

7. The method of claim 6, wherein the default values include a historical average.

8. The method of claim 1, wherein the decision module determines the range of the estimated time of arrival according to parameters for range width and accuracy.

9. The method of claim 8, wherein a resource provider associated with the retrieval location determines the parameters.

10. The method of claim 1, wherein the feature information includes aggregated features, categorical features, embedding features, and temporal features.

11. A computing device comprising:
one or more processors; and
a computer readable medium coupled to the one or more processors and containing instructions for causing the one or more processors to perform a method comprising
receiving, from an end user device, a request for a delivery;
obtaining feature information including (1) retrieval information associated with a retrieval location from which an item is to be delivered by a transporter and (2) transporter information associated with a plurality of transporter devices of transporters that are currently active for the retrieval location;
generating a feature vector from the feature information;
generating, using a machine learning model and the feature vector, a probability distribution representing probabilities for delivery times from the retrieval location;
providing the probability distribution to a decision layer that includes a plurality of decision modules associated with different retrieval locations or types of retrieval locations, wherein the retrieval information includes an identifier corresponding to the retrieval location or a type of the retrieval location;
selecting a decision module corresponding to the identifier;
generating, by the decision module, a range of an estimated time of arrival of the transporter based on the probability distribution; and
providing, to the end user device, the range of an estimated time of arrival.

12. The computing device of claim 11, wherein the machine learning model incudes a plurality of decoders, wherein each decoder is associated with a different task, and wherein a task flag is provided to the machine learning model based on a selection or lack of selection in a user interface by the end user device.

13. The computing device of claim 11, wherein generating the feature vector comprises:
encoding, using the machine learning model, (1) shared features and (2) task-specific features associated with the task flag; and
determining default values for task-specific features that are not associated with the task flag.

14. The computing device of claim 13, wherein the default values include a historical average.

15. The computing device of claim 11, wherein the feature information includes aggregated features, categorical features, embedding features, and temporal features

16. The computing device of claim 11, wherein the request for delivery comprises the retrieval location.

17. The computing device of claim 11, wherein the decision module comprises parameters for range width and accuracy.

18. The computing device of claim 11, wherein the item has been selected before receiving the request.

19. The computing device of claim 11, wherein the probability distribution includes (1) a single delivery time with the highest probability and (2) an uncertainty.

20. The computing device of claim 19 wherein the single delivery time is within the range of an estimated time of arrival.
